(19) United States
(12) Patent Application Publication
(10) Pub. No.: US 2009/0086285 A1
(43) Pub. Date: Apr. 2, 2009

(54) SCAN APPARATUS HAVING AN ADJUSTABLE LIGHT SOURCE AND SCAN METHOD THEREOF

(76) Inventor: Po-Yuan CHANG, TAINAN CITY (TW)

Correspondence Address: Muncy, Geissler, Olds & Lowe, PLLC, P.O. BOX 1364, FAIRFAX, VA, 22038-1364, US

(21) Appl. No.: 12/233,200

(22) Filed: Sep. 18, 2008

(30) Foreign Application Priority Data
Oct. 1, 2007 (TW) 096136696

(51) Int. Cl. H04N 1/04

(52) U.S. Cl. 358/475; 358/509

(57) ABSTRACT

A scan apparatus includes a control signal generating module, a light source module, a lighting module and a scanning module. The control signal generating module generates a control signal. The light source module provides light rays. The lighting module, electrically connected to the light source module and the control signal generating module, lights up a corresponding section of the light source module according to the control signal and extinguishes other sections of the light source module to output corresponding light rays to illuminate a document. The scanning module receives corresponding light rays processed by the document and generates an image signal corresponding to an image of the document.

This application claims priority of No. 096136696 filed in Taiwan R.O.C. on Oct. 1, 2007 under 35 USC 119, the entire content of which is hereby incorporated by reference.

### BACKGROUND OF THE INVENTION

1. Field of Invention

The invention relates to a scan apparatus and a scan method thereof, and more particularly to a scan apparatus having an adjustable light source and a scan method thereof.

2. Related Art

In the prior art, a light source used in a scanner is mainly produced by a cold cathode fluorescent lamp (CCFL). The CCFL pertains to a low-voltage mercury discharge lamp, which has a glass tube with an inner wall coated with fluorescent material and has the mercury filled and sealed in the glass tube.

When a high voltage is applied to the CCFL, an electrode of the lamp emits electrons, which are influenced by the electric field and are thus moved to have the kinetic energy. When the high speed electrons with the very high kinetic energy impact against the mercury of the lamp, the mercury molecules in this state instantaneously release the increased energy and suddenly return to the stable state from the unstable state such that the energy is released with the ultra-violet rays, wherein the light ray with the wavelength of 253.7 nm is the strongest light ray. The ultra-violet rays excite the fluorescent material on the inner wall of the lamp, and the electrons of the fluorescent material store the energy and then instantaneously release the energy and simultaneously release the visible light with the longer wavelength.

However, the CCFL cannot be partially lighted up. For example, when an A3-sized scanner manufactured by a manufacturer is frequently used by a user to scan an A4-sized document or a smaller-sized document, the long CCFL must be always lighted up. So, the energy is disadvantageously wasted.

### SUMMARY OF THE INVENTION

It is therefore an object of the invention to provide a scan apparatus with an adjustable light source and a scan method thereof, in which sections of a light source to be lighted up are adjusted to lower the power consumption effectively.

To achieve the above-identified object, the invention provides a scan apparatus including a control signal generating module, a light source module, a lighting module and a scanning module. The control signal generating module is for generating a control signal. The light source module is for providing light rays. The lighting module, electrically connected to the light source module and the control signal generating module, is for lighting up a corresponding section of the light source module and extinguishing other sections of the light source module according to the control signal to output corresponding light rays to illuminate a document. The scanning module is for receiving the corresponding light rays processed by the document and generating an image signal corresponding to an image of the document.

The invention also provides a scan method. The scan method includes the steps of: generating a control signal; lighting up a corresponding section of a light source module according to the control signal to output corresponding light rays to illuminate a document; and receiving the corresponding light rays, processed by the document, and thus generating an image signal corresponding to an image of the document.

Further scope of the applicability of the present invention will become apparent from the detailed description given hereinafter. However, it should be understood that the detailed description and specific examples, while indicating the preferred embodiment of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a schematic illustration showing a scan apparatus with an adjustable light source according to a preferred embodiment of the invention.

FIG. 2 is a flow chart showing a scan method according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

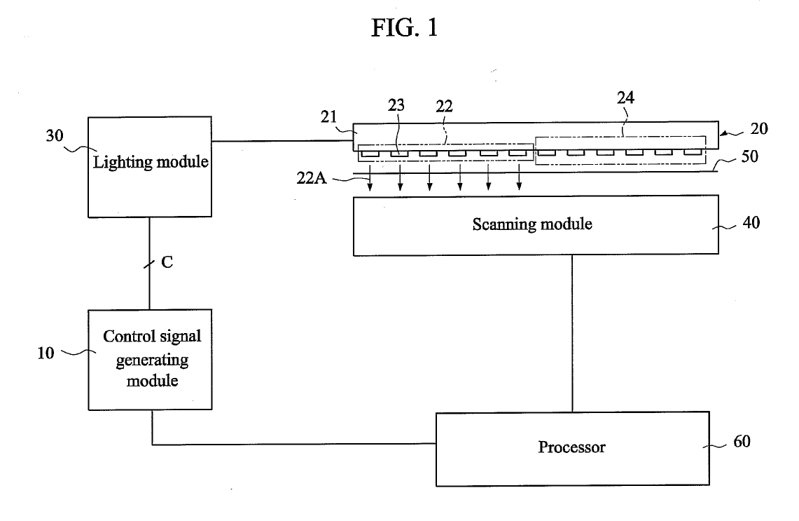

FIG. 1 is a schematic illustration showing a scan apparatus with an adjustable light source according to a preferred embodiment of the invention. Referring to FIG. 1, the scan apparatus of this embodiment includes a control signal generating module 10, a light source module 20, a lighting module 30 and a scanning module 40.

The control signal generating module 10 generates a control signal C, and the light source module 20 provides light rays. The lighting module 30, electrically connected to the light source module 20 and the control signal generating module 10, lights up a corresponding section 22 of the light source module 20 and extinguishes other sections 24 of the light source module 20 according to the control signal C to output corresponding light rays 22A to illuminate a document 50. The scanning module 40 receives the corresponding light rays 22A processed by the document 50, and generates an image signal corresponding to an image of the document 50. In this embodiment, the scanning module 40 receives the corresponding light rays 22A reflected from the document 50. In another embodiment, the scanning module may receive the corresponding light rays transmitted through the document.

The control signal generating module 10 is a document size detector for detecting size of the document 50 and thus generating the control signal C. For example, the document size detector detects that the scan width of the document is 210 mm, so the control signal C transmitted to the lighting module 30 enables the lighting module 30 to light up the corresponding section 22 having the width equal to 210 mm, for example, or 220 mm longer than 210 mm. Thus, it is possible to avoid the influence caused by the insufficient edge brightness.

Alternatively, the control signal generating module 10 is a user interface, which is operated to generate the control signal C. For example, the user operates the user interface to set the scan width to the width of 210 mm corresponding to the A4-sized sheet, so that the control signal C is generated by the control signal generating module 10. Next, the control signal C is transmitted to the lighting module 30 so that the lighting module 30 lights up the corresponding section 22 of the light source module 20 according to the control signal C. The corresponding section 22 has the width equal to 210 mm or 220 mm longer than 210 mm, for example, in order to avoid the influence caused by the insufficient edge brightness.

The light source module 20 may be composed by multiple stages of CCFLs or multiple LEDs. In this illustrated embodiment, the light source module 20 is composed of multiple LEDs. Referring again to FIG. 1, the light source module 20 includes a printed circuit board 21 and a plurality of LEDs 23, which is mounted on the printed circuit board 21 and arranged in an array. In this case, the corresponding section 22 includes plural ones of the LEDs 23. For example, if the light source module 20 includes 44 LEDs, and the maximum scan width is equal to 420 mm, the corresponding section 22 includes 22 LEDs of the 44 LEDs when the scan width is set to 210 mm.

In order to control the lighting up of the corresponding section 22, the lighting module 30 may include a voltage source and a plurality of electronic switches, such as transistors, for connecting the voltage source to the LEDs. The lighting up of the LEDs may be controlled by controlling the electronic switches.

A processor 60 may be electrically connected to the control signal generating module 10 and the scanning module 40 in order to process the output and input signals of the control signal generating module 10 and the scanning module 40.

For the sake of clear illustration, the scan apparatus of the invention is a transmissive scan apparatus, wherein the scanning module 40 receives the corresponding light rays 22A transmitted through the document 50. Alternatively, the scan apparatus of the invention may be a reflective scan apparatus, wherein the scanning module 40 receives the corresponding light rays 22A reflected from the document 50.

The scan apparatus of the invention may be a sheet-fed scan apparatus, wherein the document 50 may be moved relative to the scanning module 40, which is stationary. Alternatively, the scan apparatus of the invention may be a flatbed scan apparatus, wherein the scanning module 40 may be moved relative to the document 50, which is stationary.

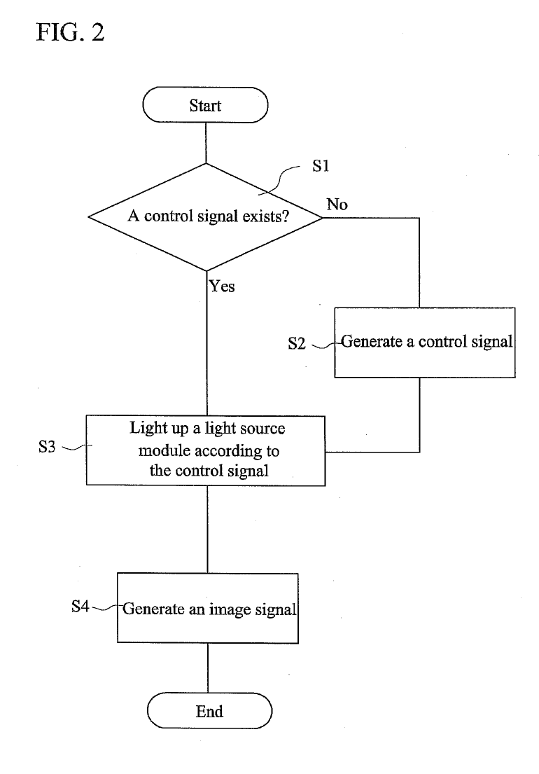

FIG. 2 is a flow chart showing a scan method according to the preferred embodiment of the invention. As shown in FIGS. 2 and 1, after the scan apparatus is turned on, the processor 60 can first detect whether the control signal C exists or not, as shown in step S1. If the control signal C does not exist, the processor 60 notifies the control signal generating module 10 to generate the control signal C, as shown in step S2. If the control signal C does exist, the lighting module 30 lights up the corresponding section 22 of the light source module 20 to output the corresponding light rays 22A to illuminate the document 50, as shown in step S3 according to the control signal C. Next, the scanning module 40 receives the corresponding light rays 22A processed by the document 50, and thus generates the image signal corresponding to the image of the document 50, as shown in step S4.

Usually, when the scan apparatus is turned on, the light source module 20 may be warmed up. In this case, the scan apparatus lights up the corresponding section 22 and the other sections 24 of the light source module 20 in advance before generating the control signal C by the control signal generating module 10. Next, after the control signal C is generated, the other sections 24 of the light source module 20 are turned off according to the control signal C. Such the operation with warming up the light source module 20 and the above-mentioned operation in which the corresponding section 22 of the light source module 20 is directly lighted up and without warming up the light source module 20, have the same effects. It is to be noted that the operation of extinguishing a section or sections of the light source module 20 in the invention may contain the operation of keeping the section or sections unlighted.

In addition to the condition where the user sets the scan width or the document size detector detects the scan width of the document, the scan apparatus of the invention may also automatically detect the scan width using the scanning module 40. In this case, the scan method of the invention further includes the following steps. First, the document is scanned according to the corresponding section 22 and the other sections 24, which are lighted up in advance, to obtain a preview image signal. Next, the processor 60 can judge the size of the document according to the preview image signal and thus the control generating module 10 generates the control signal C.

According to the scan apparatus and the scan method of the invention, the lighting section or sections of the light source module can be effectively controlled. When the maximum scan width of the scan apparatus is gradually increased, effectively controlling the lighted section or sections of the light source module can save the power. In addition, when the lighted section or sections of the light source module are known, the scan apparatus or the host apparatus connected thereto may separate the background from the document more precisely and efficiently when an automatic frame cropping operation is performed because the difference between the gray-scale levels in the scan areas of the corresponding lighted section and in the background areas of the corresponding unlighted section is larger than the difference between the gray-scale levels in the scan areas of the corresponding lighted section and in the background areas of the corresponding lighted section. Alternatively, when the scan apparatus of the invention is used in conjunction with a print apparatus, a printing range of the print apparatus may be set according to the control signal. That is, the print apparatus can control the printing range according to the lighted section of the light source module to prevent the consumable material, such as toner or ink, from being wasted.

While the invention has been described by way of examples and in terms of a preferred embodiment, it is to be understood that the invention is not limited thereto. To the contrary, it is intended to cover various modifications. Therefore, the scope of the appended claims should be accorded the broadest interpretation so as to encompass all such modifications.

What is claimed is:

1. A scan apparatus, comprising:
a control signal generating module for generating a control signal;
a light source module for providing light rays;
a lighting module, electrically connected to the light source module and the control signal generating module, for lighting up a corresponding section of the light source module and extinguishing other sections of the light source module according to the control signal to output corresponding light rays to illuminate a document;
a scanning module for receiving the corresponding light rays, processed by the document, and generating an image signal corresponding to an image of the document.

2. The scan apparatus according to claim 1, wherein the control signal generating module is a document size detector for detecting size of the document and thus generating the control signal.

3. The scan apparatus according to claim 1, wherein the control signal generating module is a user interface being operated to generate the control signal.

4. The scan apparatus according to claim 1, wherein the light source module comprises a printed circuit board and a plurality of light-emitting diodes (LEDs), wherein the LEDs are disposed on the printed circuit board and arranged in an array.

5. The scan apparatus according to claim 4, wherein the corresponding section comprises plural ones of the LEDs.

6. The scan apparatus according to claim 1, wherein the lighting module comprises a voltage source and a plurality of electronic switches connecting the voltage source to the LEDs, wherein the LEDs are controlled to light up by controlling the switches.

7. The scan apparatus according to claim 1, wherein the scanning module receives the corresponding light rays reflected from the document.

8. The scan apparatus according to claim 1, wherein the scanning module receives the corresponding light rays transmitting through the document.

9. The scan apparatus according to claim 1, wherein the document can be moved relative to the scanning module, which is stationary.

10. The scan apparatus according to claim 1, wherein the scanning module can be moved relative to the document, which is stationary.

11. A scan method, comprising the steps of:
generating a control signal;
lighting up a corresponding section of a light source module according to the control signal to output corresponding light rays to illuminate a document; and
receiving the corresponding light rays, which are processed by the document, and thus generating an image signal corresponding to an image of the document.

12. The method according to claim 11, further comprising the steps of:
lighting up the corresponding section and other sections of the light source module in advance before the control signal is generated; and
extinguishing the other sections of the light source module according to the control signal after the control signal is generated.

13. The method according to claim 12, further comprising the steps of:
scanning the document using the corresponding section and the other sections, which are lighted up in advance to obtain a preview image signal; and
judging size of the document according to the preview image signal to generate the control signal.

14. The method according to claim 11, wherein the control signal is generated by a document size detector.

15. The method according to claim 11, wherein the control signal is generated through a user interface being operated.

16. The method according to claim 11, wherein the light source module comprises a printed circuit board and a plurality of LEDs, which is disposed on the printed circuit board and arranged in an array.
